(19) United States
(12) Patent Application Publication
(10) Pub. No.: US 2012/0304632 A1
(43) Pub. Date: Dec. 6, 2012

(54) Oil jet for increased efficiency

(76) Inventor: Scott Clair Pockrandt, Ridgecrest, CA (US)

(21) Appl. No.: 13/506,123

(22) Filed: Mar. 29, 2012

Related U.S. Application Data
(60) Provisional application No. 61/518,458, filed on May 2, 2011.

(51) Int. Cl. F02B 75/12

(52) U.S. Cl. 60/327

(57) ABSTRACT

The Oil Jet for Increased Efficiency system makes use of internally developed, and stored, oil pressure to direct additional force to assist moving parts in an internal combustion engine, rotating device of any nature, and/or any power producing mechanism, to assist in overcoming frictional, compression, drag, and other resistive forces within said mechanism in order to increase efficiency.

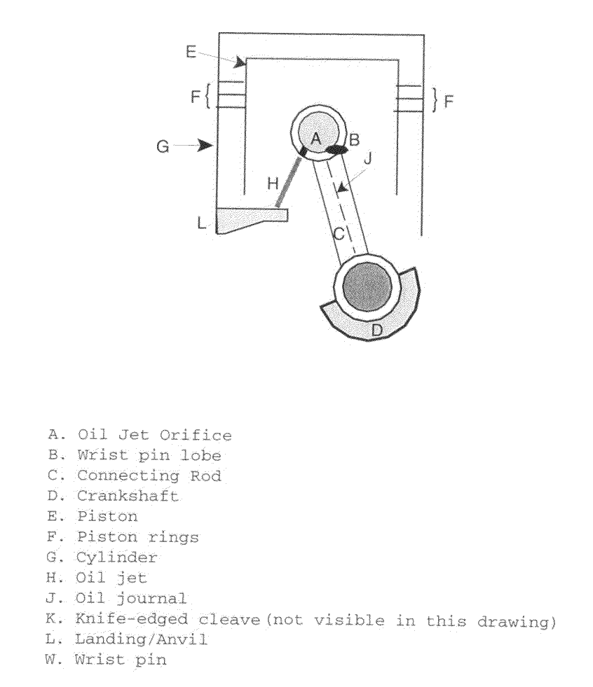

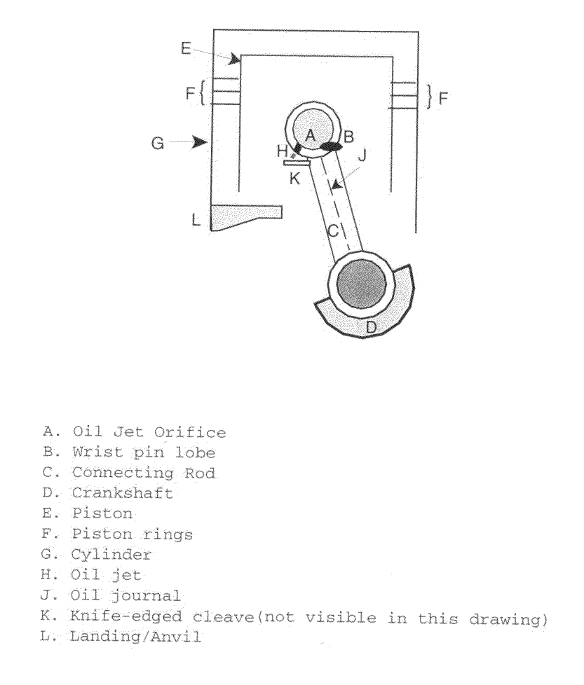

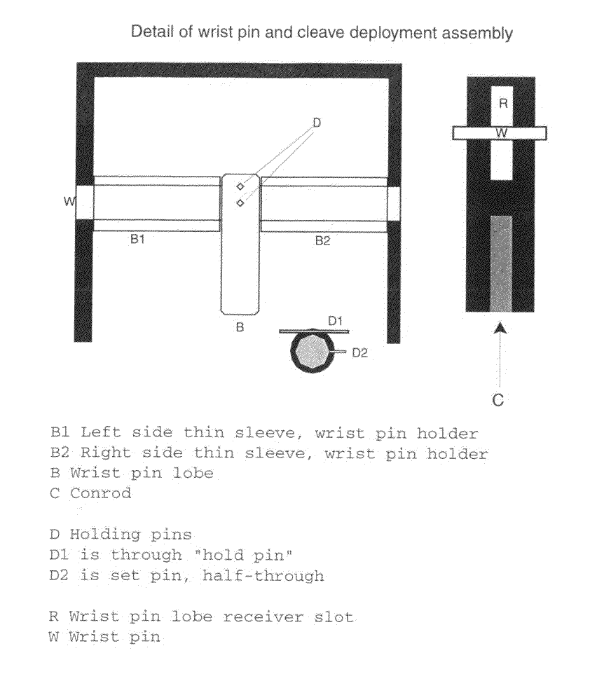

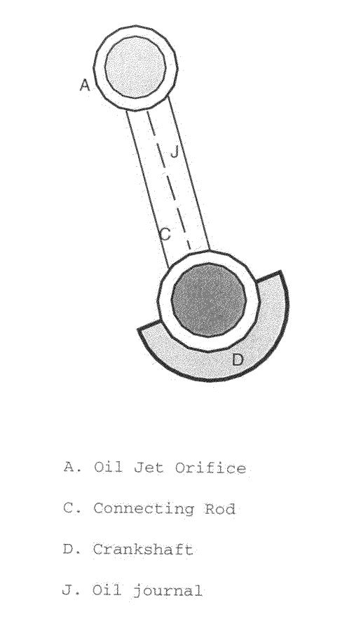

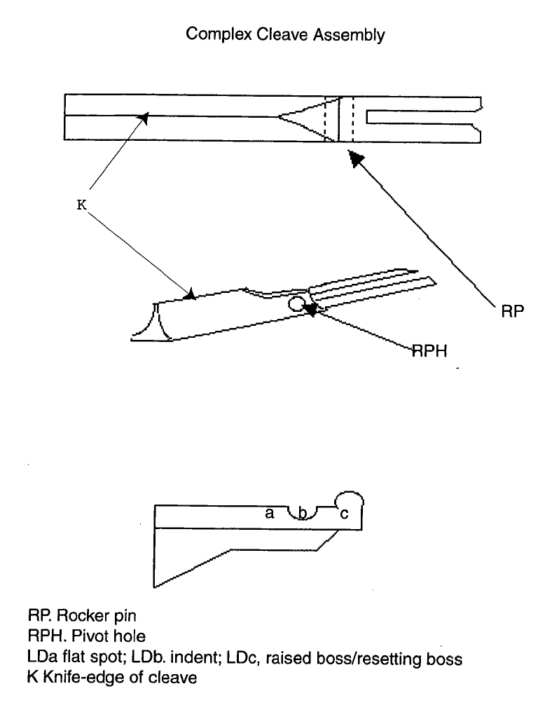

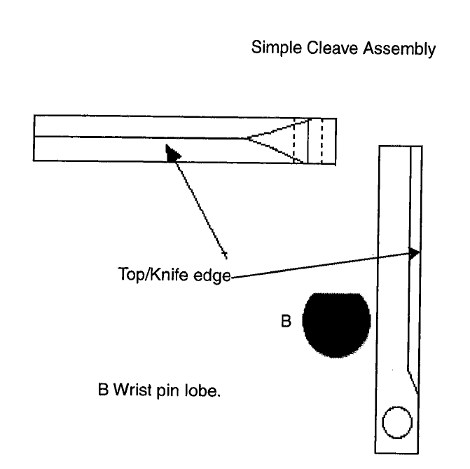

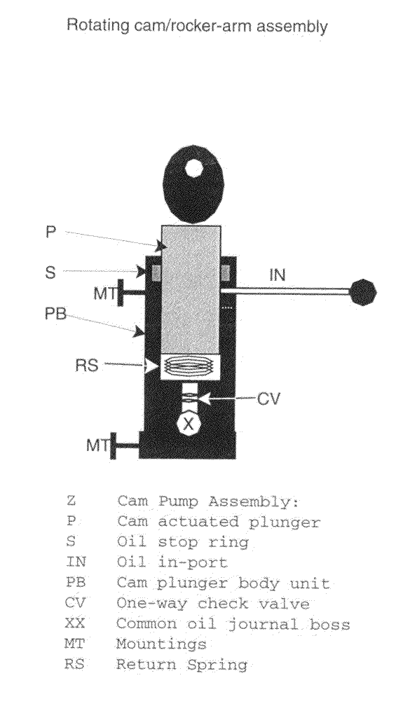

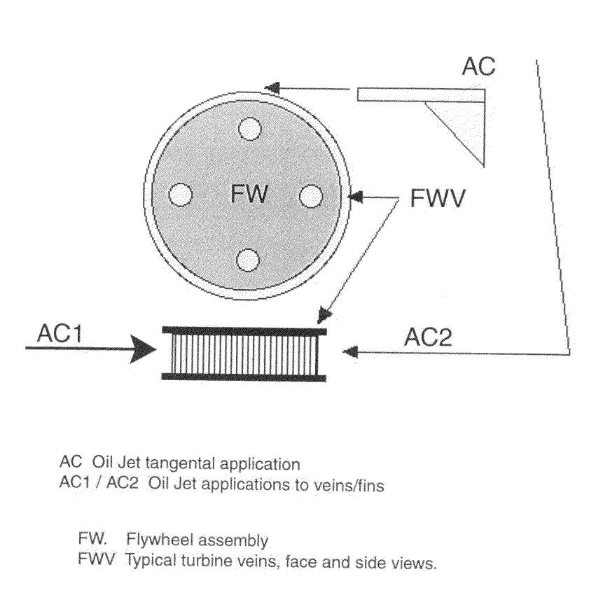

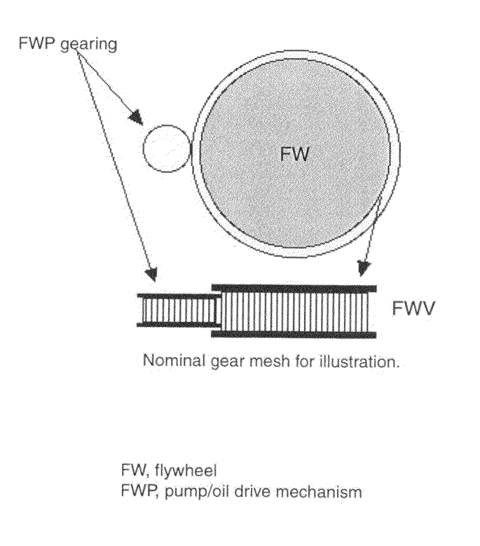

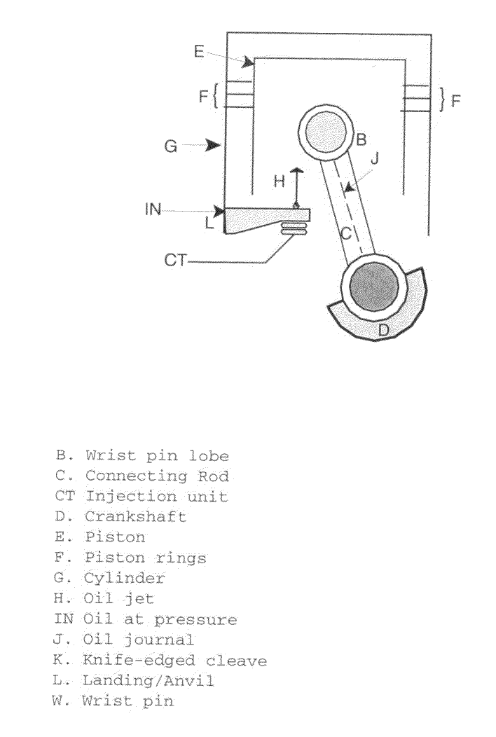

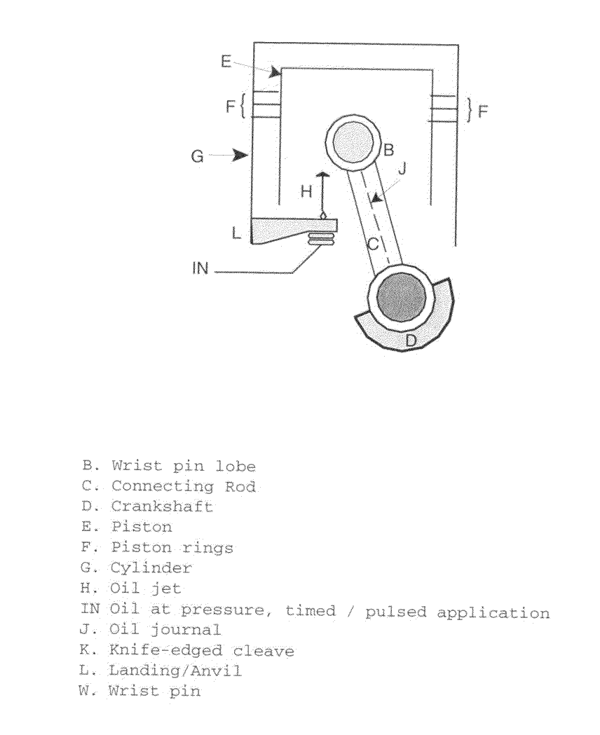

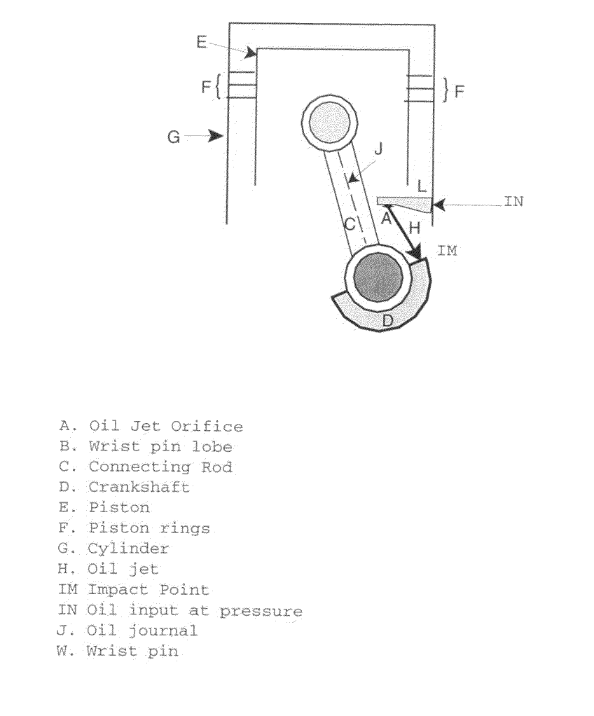

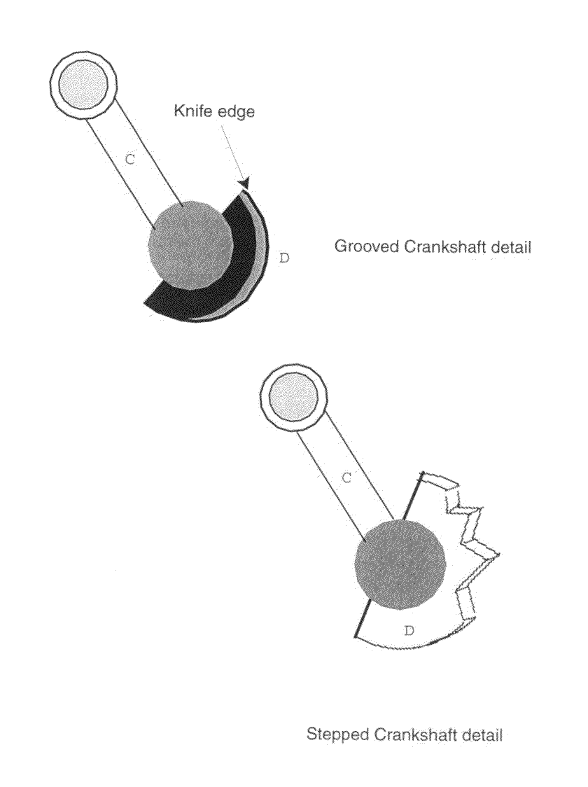

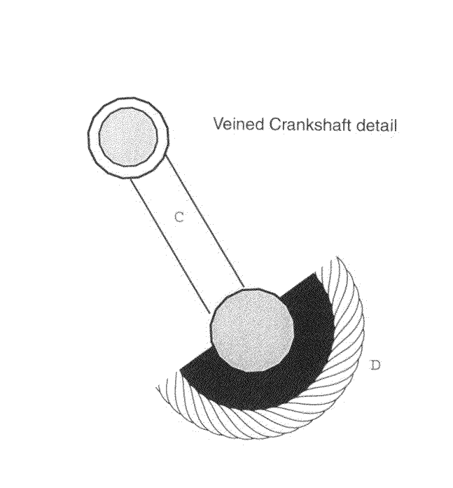

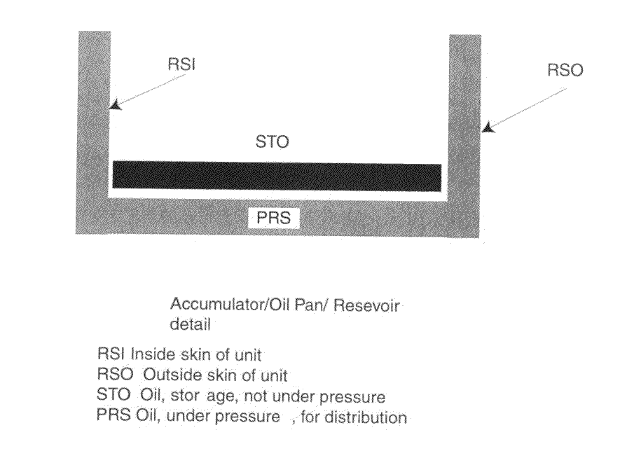

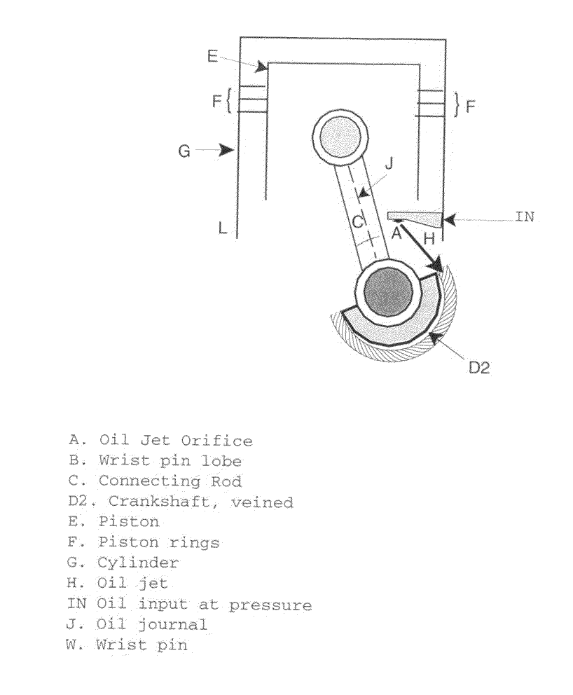

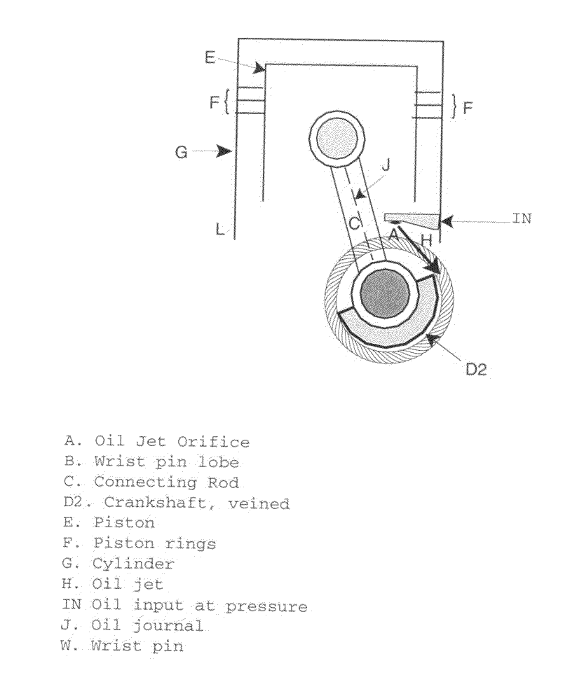

Applications include, but are not limited to, timed application of said oil jet to assist in compression and exhaust strokes. Stead-state and/or timed application to rotating parts, including flywheel, alternator, transmission parts and other rotating parts to provide continuous additional force to assist in overcoming mechanical, frictional and other losses within the system.

This application claims priority from Provisional Application No. 61/518,458 filed on May 2, 2011

### FEDERALLY SPONSORED RESEARCH

Not applicable.

### SEQUENCE LISTING OR PROGRAM

Not applicable.

### BACKGROUND

1. Field

This application relates to reduction/elimination of greenhouse gas emissions. Increased efficiency of engines, motors, and all rotational and/or reciprocating power generating devices.

No one else has yet produced a method as described herein to reduce and overcome frictional and other drag losses within.

No previous process or method has been utilized to use the latent and continuous pressure within the power generating and delivery systems described herein, to overcome drag, friction and other mechanical losses, in the manner set forth.

2. Prior Art

As submitted with provisional patent referenced above.

### DRAWINGS

Drawing 1:

Shows the overall operation of the oil jet, directed flow, with an interrupting cleave in both the deployed and retracted, or non-deployed, positions, and gives a general legend for all drawings.

Drawing 2:

Shows expanded view of cleave and wrist pin assemblies, and how they interconnect, and operate in the system, to apply or divert the oil jet flow.

Drawing 3:

Shows a very basic example of the groove in the conrod. This is not to scale and is included for information only.

Drawing 4:

Shows details of the cleave assembly, and how it can be formed to accomplish deployment to divert the oil jet during compression and exhaust strokes.

Drawing 5:

Shows a simplified cleave assembly for use in other applications as required.

Drawing 6:

Shows side-by-side comparison of the open/deployed and closed/retracted or non-deployed conditions of the diversion cleave.

Drawing 7:

Shows rotating campump assembly used in manifold distribution system for continuously pressurized system, and for use with electrically and/or hydraulically controlled system.

Drawing 8:

Shows application to any rotating part of any engine, motor or other power generating and/or delivery system, including but not limited to transmission, alternator, cv joint/gear, differential, flywheel, or other rotating part(s).

Drawing 9:

Shows application of directly or indirectly driven pump/motor assembly, using pressurized system to return energy to the compressing drive mechanism during times of need.

Drawing 10:

Shows application of a timed, electrically actuated, system utilizing a static source high pressure oil supply.

Drawing 11:

Shows application of a timed, pulsating oil jet, allowing for pulse duration control for various applications.

Drawings 12:

Show application of a timed, hydraulically actuated, system utilizing a static source high pressure oil supply.

Drawing 13:

Shows application of a timed, hydraulically actuated, system utilizing a pulsating oil jet.

Drawing 14:

Shows detail of pulsating oil jet. Noting that as distance of stroke increases, efficiency can decrease. Use of pulsating jet allows for greater duration when more distance in encountered, thereby averaging the pressure applied over the entire stoke path. Also shown is addition of diverter cleave, as necessary to provide positive diversion of oil jet when appropriate.

Drawing 15:

Shows direction of oil jet onto crankshaft, or other mounting/driving part.

Drawing 16:

Shows construction, generally, of the knife-edged or stepped shape of crankshaft or other mounting/driving part in Drawing 15.

Details of drawings are included in the drawings themselves, all parts shown indicate use in common internal combustion engine, showing the cylinder, piston, connecting rod (conrod), crankshaft, electrical components and other common parts.

Drawing 7 is exceptional in this respect as it details an internally mounted campump, which utilizes the flywheel inertial energy, coupled with electrical assisting motor, to pressurize a manifold distribution system for maintaining high pressure for use in the oil jet.

The operation uses the application of a high pressure oil jet to assist the “upward” or compressing stroke and the exhaust stroke of an internal combustion engine to aid in overcoming resistance, and frictional forces during this part of the engine operation.

The oil jet is diverted during the power and intake strokes, to allow for free movement.

Oil jet can be utilized to replace “back pressure” to slow vehicle as well during deceleration periods. See Drawing 8, with oil jet reversing effect.

The oil jet is either timed, or diverted mechanically during the proper strokes, and is maintained at a sufficient pressure to be utilized to overcome and/or eliminate power-robbing frictional and compression forces in the engine.

The oil jet can be applied to any rotating device, at any point to assist in overcoming drag or frictional forces, and uses otherwise wasted over-pressure in the system for this purpose.

1: I have developed a process and method of reducing frictional/compression losses of an internal combustion engine and/or any rotating engine or other power producing device, comprising the steps of:
a. applying a jet of high pressure oil, or other liquid, to the piston, crankshaft or other mounting/drive mechanism, and;
b. directing said oil jet to a landing, divet or other structure, and;
c. using the pressure of said oil jet to assist in the movement of the piston, or other structure, in such a manner as to assist in overcoming frictional/compression and/or other drag forces within said engine and/or other power producing device.

2: I have developed a process and method of utilizing momentum, inertia and/or other waste energy and/or external sources of power, together with any internally generated power within an engine and/or other power producing devices, to recycle within said engine and/or other power producing devices comprising the steps of:
a. applying the inertial and/or other waste movement energies to a pressurizing mechanism, and;
b. using that pressurizing mechanism to pressurize an accumulator, manifold or other storage and distribution assembly, and;
c. applying said pressure to drive parts of the engine and/or other power producing mechanism reducing the amount of external energy used. (e.g. fossil fuels)

3: I have developed a process and method of utilizing momentum, inertia and/or other waste energy and/or external sources of power, together with any internally generated power within an engine and/or other power producing devices, to capture waste energy for recycling within said engine and/or other power producing devices comprising the steps of:
a. actuating a pressurizing mechanism and the end of a power stroke, during inertial movement of a piston, or other rotating power device, and;
b. using said movement to pressurize a manifold and/or other storage and delivery assembly, and;
c. directing and/or timing the release of said pressure through an oil jet, and;
d. applying the stored energy to assist in compression, exhaust and/or other strokes, or movements of the piston, or other rotating power device, to overcome resistance of frictional or other drag forces.
